(19) United States
(12) Patent Application Publication
(10) Pub. No.: US 2019/0310477 A1
(43) Pub. Date: Oct. 10, 2019

(54) Head-mounted Display Device and Adjustment Parameter Determining Method for Head-mounted Display Device

(71) Applicant: BEIJING 7INVENSUN TECHNOLOGY CO., LTD., Beijing (CN)

(72) Inventors: Dongchun REN, Beijing (CN); Bing XIAO, Beijing (CN); Xuehui YANG, Beijing (CN); Tongbing HUANG, Beijing (CN)

(21) Appl. No.: 16/334,763

(22) PCT Filed: Dec. 28, 2017
(86) PCT No.: PCT/CN2017/119183

§ 371 Date: Mar. 20, 2019

(30) Foreign Application Priority Data
Dec. 30, 2016 (CN) 201611262761.X

(51) Int. Cl. G02B 27/01

(52) U.S. Cl. CPC G02B 27/0172; G02B 27/0176

(57) ABSTRACT

A head-mounted display device and an adjustment parameter determining method for the head-mounted display device are provided. The head-mounted display device (100) includes a display screen (101), and further includes a focusing component (102), an optometric component (103) and a control component (104). The focusing component (102) is arranged in front of the display screen (101), and the control component (104) is electrically connected with the optometric component (103). The focusing component (102) is configured to focus incident light during emergence. The optometric component (103) is configured to test a diopter of an eyeball of a user. The control component (104) is configured to determine at least one of a target focal length of the focusing component (102) and a target distance between the display screen (101) and the focusing component (102) according to the diopter.

### TECHNICAL FIELD

The present disclosure relates to the technical field of displays, and particularly to a head-mounted display device and an adjustment parameter determining method for the head-mounted display device.

### BACKGROUND

A head-mounted display device is a completely new technology in modern display technologies. Development of a high-resolution image reconstruction technology, perfection of a binary optic theory and design and maturation of a holographic technology develop new approaches for the design of head-mounted display device and also promote emergence of more and more head-mounted display devices into public consciousness.

For meeting using requirements of various people, a distance between a lens and a display screen of an existing head-mounted display device may be adjusted, thereby enabling a user suffering from ametropia to use the head-mounted display device. However, the head-mounted display device in related art may not be accurately adjusted for adaptation to normal use of the user suffering from ametropia. During the user suffering from ametropia uses the head-mounted display device, if the user wants to acquire a clear image from the display screen, the user may adjust the distance between the display screen and the lens by subjective judgment. Consequently, an adjustment result is not so accurate.

### SUMMARY

At least some embodiments of the present disclosure provide a head-mounted display device and an adjustment parameter determining method for the head-mounted display device, so as at least partially to solve a problem that the head-mounted display device in the related art may not be accurately adjusted for adaptation to normal use of a user suffering from ametropia and further improve adjustment precision of the head-mounted display device.

In an embodiment of the present disclosure, a head-mounted display device is provided, which includes a display screen and further includes a focusing component, an optometric component and a control component, and the focusing component is arranged in front of the display screen, and the control component is electrically connected with the optometric component; the focusing component is configured to focus incident light during emergence; the optometric component is configured to test a diopter of an eyeball of a user; and the control component is configured to determine at least one of a target focal length of the focusing, component and a target distance between the display screen and the focusing component according to the diopter.

In an optional embodiment, the diopter includes an ametropia value or an ametropia degree.

In an optional embodiment, the head-mounted display device further includes a prompting component, and the prompting component is connected with the control component; and the, prompting component is configured to prompt the user according to at least one of the target focal length and the target distance.

In an optional embodiment, the head-mounted display device further includes an execution component, and the execution component is respectively connected with the control component, the display screen and the focusing component; the focusing component includes multiple lenses corresponding to different diopters; the control component is further configured to control the execution component to drive at least one of the display screen and the focusing component to move according to the target distance, or, is further configured to control the execution component to replace the lens according to the target focusing length; and the execution component is configured to drive at least one of the display screen and the focusing component to move according to control of the control component or manual control of a user, or, replace the lens according to control of the control component or manual control of a user.

In an optional embodiment, the execution component includes a driving mechanism and a transmission mechanism, the driving mechanism is respectively connected with the control component and the transmission mechanism, and the transmission mechanism is respectively connected with the display screen and the focusing component; the driving mechanism is configured to drive the transmission mechanism to move according to control of the control component or manual control of the user; and the transmission mechanism is configured to drive at least one of the display screen and the focusing component to move according to driving of the driving mechanism or manual control of the user, or, replace the lens according to driving of the driving mechanism or manual control of the user.

In an optional embodiment, the driving mechanism includes a stepper motor or a servo motor.

In an optional embodiment, the transmission mechanism includes a lead screw transmission mechanism, a rack transmission mechanism or a gear transmission mechanism.

In an optional embodiment, the focusing component includes a liquid crystal lens; and the control component is further configured to control zooming of the liquid crystal lens of the focusing component according to the target focal length.

In an optional embodiment, the prompting component includes at least one of a voice component and a display component.

In another embodiment of the present disclosure, a adjustment parameter determining method for a head-mounted display device is provided, the head-mounted display device being the above-mentioned head-mounted display device and the method includes that: a focusing component is made still relative to a display screen;

a diopter of an eyeball of a user is tested through an optometric component; and

at least one adjustment parameter is determined through a control component according to the diopter, the adjustment parameter including at least one of a target focal length of the focusing component and a target distance between the display screen and the focusing component.

According to the head-mounted display device and adjustment parameter determining method for the head-mounted display device provided in at least some embodiments of the present disclosure, the diopter of the user is acquired, and then at least one of the target focal length of the focusing component and the target distance between the display screen and the focusing component is determined according to the diopter, so that a basis is provided for adjusting at least one of the distance between the display screen and the focusing component and the focal length of the focusing component, and adjustment precision of the head-mounted display device is further improved.

### BRIEF DESCRIPTION OF THE DRAWINGS

In order to describe the technical solutions of the embodiments of the present disclosure more clearly, the drawings required to be used for the embodiments will be simply introduced below. It is to be understood that the following drawings illustrate some embodiments of the present disclosure and thus should not be considered as limits to the scope. Those of ordinary skill in the art may further obtain other related drawings according to these drawings without creative work.

FIG. 1 shows a structural diagram of a head-mounted display device according to a first exemplary embodiment of the present disclosure.

FIG. 2 shows a structural diagram of a head-mounted display device according to a second exemplary embodiment of the present disclosure.

FIG. 3 shows a structural diagram of a head-mounted display device according to a third exemplary embodiment of the present disclosure.

FIG. 4 shows a structural diagram of automatically controlling a focusing component to move according to an embodiment of the present disclosure.

FIG. 5 shows a structural diagram of manually controlling a focusing component to move according to an embodiment, of the present disclosure.

FIG. 6 shows a structural diagram of automatically controlling a display screen to move according to an embodiment of the present disclosure.

FIG. 7 shows a structural diagram of manually controlling a display screen to move according to an embodiment of the present disclosure.

FIG. 8 shows a structural diagram of automatically controlling a focusing component to replace a lens according to an embodiment of the present disclosure.

FIG. 9 shows a structural diagram of manually controlling a focusing component to replace a lens according to an embodiment of the present disclosure.

FIG. 10 shows a structural diagram of a head-mounted display device according to a fourth exemplary embodiment of the present disclosure.

FIG. 11 shows a flowchart of an adjustment parameter determining method for a head-mounted display device according to an embodiment of the present disclosure.

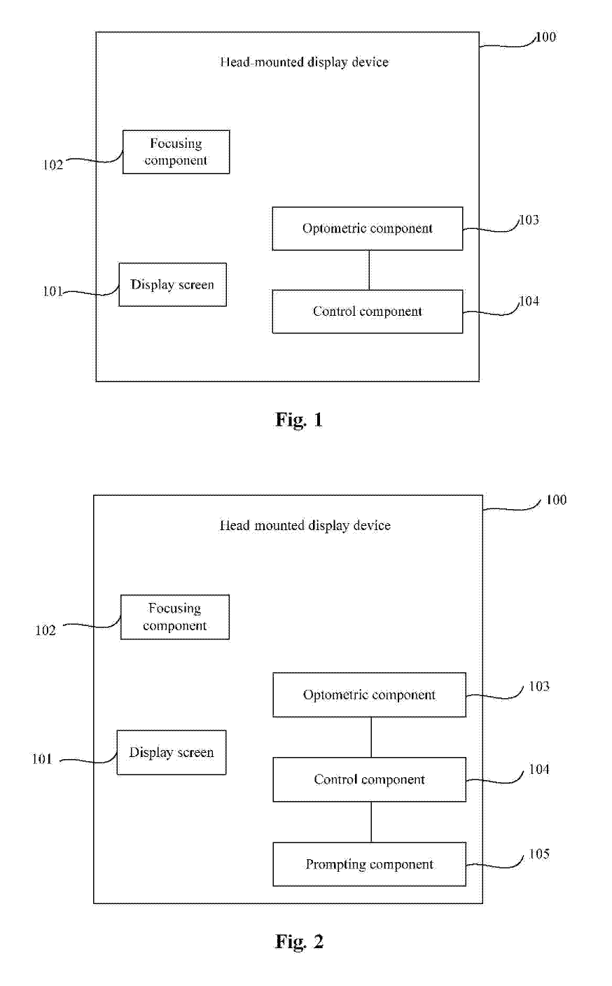

Descriptions about main drawing reference signs in FIG. 1:

100: head-mounted display device; 101: display screen; 102: focusing component; 103: optometric component; and 104: control component.

Descriptions about main drawing reference signs in FIG. 2:

105: prompting component.

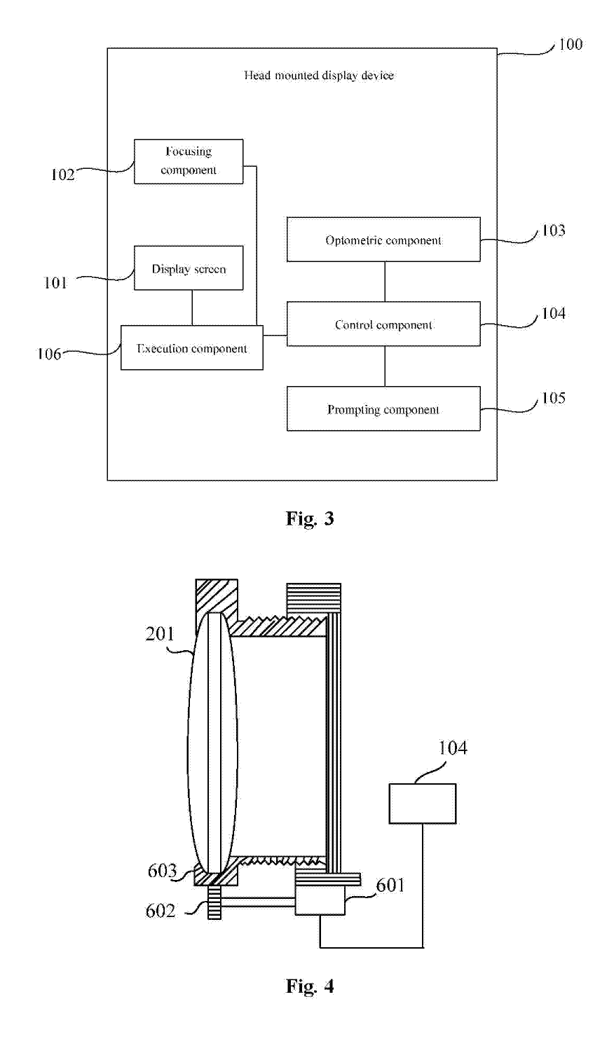

Descriptions about main drawing reference signs in FIG. 3:

106: execution component.

Descriptions about main drawing reference signs in FIG. 4:

201: original lens; 601: motor; 602: driving gear; and 603: driven gear.

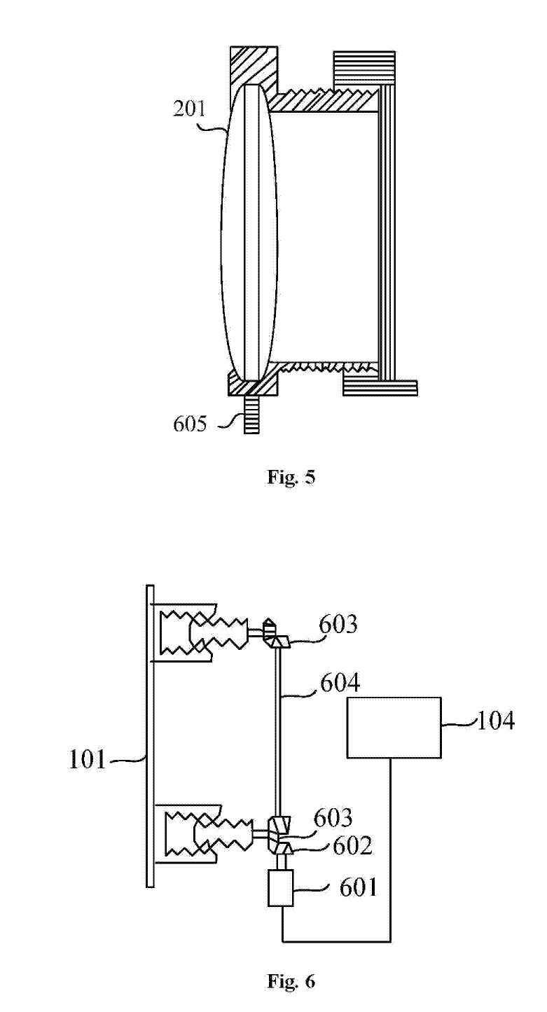

Descriptions about main drawing reference signs in FIG. 5:

605: knob.

Descriptions about main drawing reference signs in FIG. 6:

604: connecting rod.

Descriptions about main drawing reference signs in FIG. 8:

202: lens corresponding to focal length.

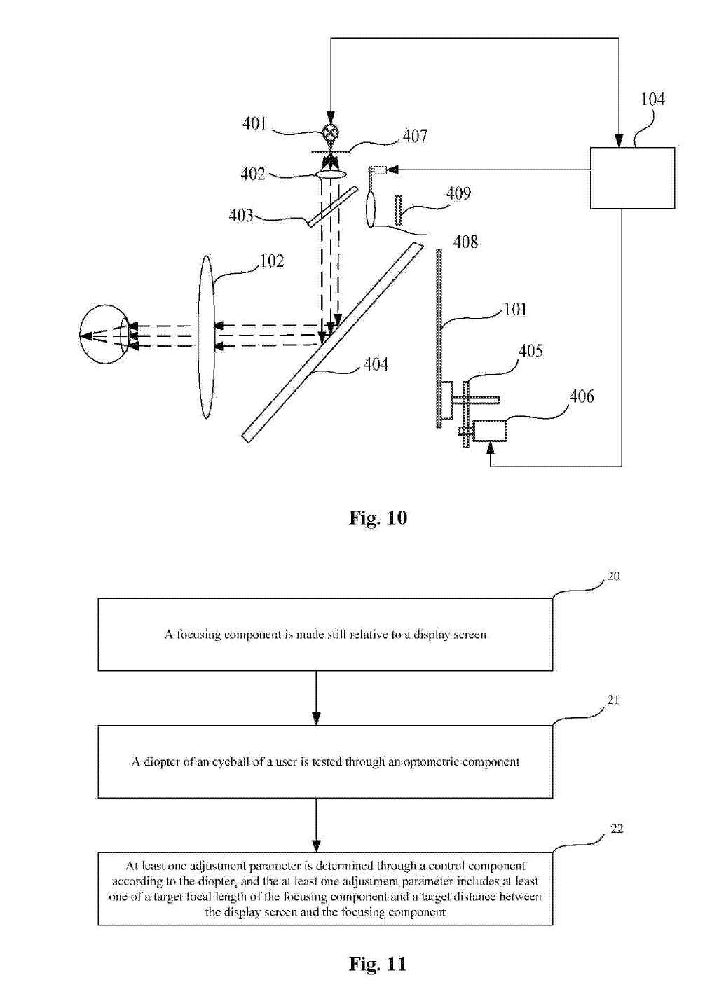

Descriptions about main drawing reference signs in FIG. 10:

401: infrared light emission device; 402: light shaping lens; 403: spectroscope; 404: dichroic mirror; 405: transmission mechanism: 406: driving mechanism; 407: diaphragm; 408: fundus imaging lens; and 409: image sensor.

### DETAILED DESCRIPTION

In order to make the purpose, technical solutions and advantages of the embodiments of the present disclosure clearer, the technical solutions in the embodiments of the present disclosure will be clearly and completely described below in combination with the drawings in the embodiments of the present disclosure. It is apparent that the described embodiments are not all embodiments but part of embodiments of the present disclosure. Components described and illustrated in the drawings in the embodiments of the present disclosure may usually be arranged and designed with various configurations. Therefore, the following detailed descriptions about the embodiments of the present disclosure provided in the drawings are not intended to limit the scope of the claimed present disclosure but represent selected embodiments of the present disclosure. All other embodiments obtained by those skilled in the art on the basis of the embodiments of the present disclosure without creative work shall fall within the scope of protection of the present disclosure.

Considering that a user directly manually adjust a rotating handle or a knob according to a subjective feeling to adjust a distance between a lens and display screen of an existing head-mounted display device and thus an adjustment result is not so accurate, on such a basis, an embodiment of the present disclosure provides a head-mounted display device and an adjustment method for the head-mounted display device. Descriptions will be made below through embodiments.

### Embodiment One

Embodiment one of the present disclosure provides a head-mounted display device 100. As shown in FIG. 1, the head-mounted display device includes a display screen 101, a focusing component 102, an optometric component 103 and a control component 104. Herein, the focusing component 102 is arranged in front of the display screen 101, and the control component 104 is electrically connected with the optometric component 103.

The focusing component 102 is configured to focus incident light during emergence. The optometric component 103 is configured to test a diopter of an eyeball of a user. The control component 104 is configured to determine at least one of a target focal length of the focusing component 102 and a target distance between the display screen 101 and the focusing component 102 according to the diopter.

The diopter includes an ametropia value or an ametropia degree. Ametropia of the eyeball of the user includes myopia, hyperopia or astigmatism. The ametropia value refers to determined degrees of the eyeball of the user. For example, the eyeball of the user has myopia of 200 degrees. The ametropia degree includes a corresponding myopia degree, hyperopia degree or astigmatism degree. For example, it is detected that the myopia degree of the user is 200 degrees to 300 degrees.

The display screen 101 includes a liquid crystal display screen, a light-emitting diode display screen and an organic light-emitting diode display screen. A specific type of the display screen 101 is not limited herein.

The following conditions may exist for the focusing component 102.

At a first condition, the focusing component 102 includes one fixed focal length lens.

When the focusing component 102 includes one fixed focal length lens and ametropia of an eye of the user is tested, a distance between the focusing component 102 and the display screen 101 is adjusted to the target distance by changing at least one of position of the focusing component 102 and the display screen 101.

At a second condition, the focusing component 102 includes multiple lenses corresponding to different diopters, i.e., spherical lenses suitable for eyeballs with myopia or hyperopia and cylindrical lenses suitable for eyeballs with astigmatism.

At a third condition, the focusing component 102 includes one variable focal length lens.

In an exemplary implementation mode disclosed in embodiment one of the present disclosure, a determined ametropia value of the eyeball of the user is tested by an optometric unit. And before the diopter of the user is tested, a lens with a known focal length is selected and recorded as a first lens in a manner that a luminous surface of the display screen 101 is perpendicular to an optical axis of the first lens and is overlapped with a focal plane of the first lens.

When the user uses the head-mounted display device 100, if the ametropia value D of the eyeball of the user is acquired by testing of the optometric component 103 and determination of the control component 104 and the ametropia value D of the eyeball of the user, a focal length F′ of the focusing component 102 and the distance L′ between the focusing component 102 and the display screen 101 meet the following formula (1), the user with the ametropia value D may clearly see an optotype on the display screen 101 through the focusing component 102.

And the ametropia value D, the focal length F′ of the focusing component 102 and the distance L′ between the focusing component 102 and the display screen 101 are represented by the following equation (1):

1/L′+D/100=1/F′ (1)

where D is the ametropia value of the eyeball of the user to be tested, L′ is the target distance between the focusing component 102 and the display screen 101, and P is the target focal length of the focusing component. During specific use, when the optometric component 103 of the head-mounted display device 100 acquires the ametropia value D, the following adjustment solutions may be adopted. Detailed descriptions will be made below.

At first, the ametropia value D is known, and the distance between the lens and the display screen 101 is adjusted to the target distance L′ by adjusting the position of the lens without changing the lens with the known focal length in the focusing component 102 and the position of the display screen 101.

At second, the ametropia value D is known, and the distance between the display screen 101 and the lens is adjusted to the target distance L′ by adjusting the position of the display screen 101 without changing the lens with the known focal length in the focusing component 102 and, the position of the lens.

At third, the ametropia value D is known, and the focal length of the focusing component 102 is adjusted to the target focal length P by replacing the lens with a lens with a different focal length in the focusing component 102 without changing the positions of the display screen 101 and the focusing component 102.

At fourth, the ametropia value D is known, and the distance between the focusing component 102 and the display screen 101 is adjusted to the target distance L′ and the focal length of the focusing component 102 is simultaneously adjusted to the target focal length F′ by simultaneously changing a position relationship between the focusing component 102 and the display screen 101 and replacing the lens in the focusing component 102.

A specific form of the focusing component 102 may further include a liquid crystal lens. When the focusing component 102 includes the liquid crystal lens, the control component 104 is further configured to change a focal length of the liquid crystal lens of the focusing component 102 according to the target focal length.

In an exemplary implementation mode disclosed in embodiment one of the present disclosure, the optometric component 102 tests the eyeball of the user to determine the ametropia degree of the eyeball of the user. For example, the optometric component 103 determines that the eyeball of the user has myopia and the ametropia degree of the eyeball is about 200 degrees to 300 degrees, and then the control component 104 may determine a range corresponding to the focal length of the liquid crystal lens according to the range from 200 degrees to 300 degrees, thereby adjusting the focal length of the liquid crystal lens to a proper degree, and then changes a distance between the liquid crystal lens and the display screen 101 to enable the user to obtain a clear optotype.

In an exemplary implementation mode disclosed in embodiment one of the present disclosure, as shown in FIG. 2, the head-mounted display device 100 further includes a prompting component 105. And the prompting component 105 is connected with the control component 104. And the prompting component 105 is configured to prompt the user according to at least one of the target focal length F′ and the target distance L′.

The prompting component 105 includes at least one of a voice component and a display component. In an exemplary implementation mode disclosed in embodiment one of the present disclosure, the prompting component 105 prompts the, user through a voice broadcast.

In an exemplary implementation mode disclosed in embodiment one of the present disclosure, as shown in FIG. 3, the head-mounted display device 100 further includes an execution component 106. And the execution component 106 is respectively connected with the control component 104, the display screen 101 and the focusing component 102.

In an exemplary implementation mode disclosed in embodiment one of the present disclosure, the focusing component 102 includes multiple lenses corresponding to different diopters, namely having multiple lenses with different focal lengths. And the control component 104 is further configured to control the execution component 106 to drive at least one of the display screen 101 and the focusing component 102 to move according to the target distance, or, is further configured to control the execution component 106 to replace the lens according to the target focusing length.

The execution component 106 is configured to drive at least one of the display screen 101 and the focusing component 102 to move according to control of the control component 104 or manual control of the user, or, replace the lens according to control of the control component 104 or manual control of the user.

The execution component 106 includes a driving mechanism and a transmission mechanism. The driving mechanism is respectively connected with the control component 104 and the transmission mechanism. And the transmission mechanism is respectively connected with the display screen 101 and the focusing component 102.

The driving mechanism is configured to drive the transmission mechanism to move according to control of the control component 104 or manual control of the user. And the transmission mechanism is configured to drive at least one of the display screen 101 and the focusing component 102 to move according to driving of the driving mechanism or manual control of the user, or, replace the lens according to driving of the driving mechanism or manual control of the user.

The driving mechanism includes a stepper motor or a servo motor. And the transmission mechanism includes a lead screw transmission mechanism, a rack transmission mechanism or a gear transmission mechanism. Specific structures of the driving mechanism and the transmission mechanism are not specifically limited herein.

For automatic adjustment and manual adjustment conditions, detailed descriptions will be made below respectively.

Adjustment of the position of the lens includes the following two conditions.

At a first condition, when the execution component 106 drives a lens 201 in the focusing component 102 to move according to control of the control component 104, as shown in FIG. 4, the driving mechanism is a motor 601, the transmission mechanism is a gear transmission mechanism, divided, into a driving gear 602 and a driven gear 603. And the motor 601 drives the driving gear 602 to drive the driven gear 603 to move the lens 201 according to control of the control component 104.

At a second condition, when the execution component 106 drives the lens 201 of the focusing component 102 to move according to manual control of the user, as shown in FIG. 5, the driving mechanism of the execution component 106 is a knob 605, and the user adjusts the transmission mechanism to drive the lens to move through the knob 605.

Adjustment of the position of the display screen 101 includes the following two conditions.

At a first condition, when the execution component 106 drives the display screen 101 to move according to control of the control component 104, as shown in FIG. 6, the driving mechanism is the motor 601, the transmission mechanism is a gear transmission, divided into the driving gear 602, the driven gear 603 and a connecting rod 604. And the motor 601 drives the driving gear 602 to drive the driven gear 603 to move the display screen 101 according to control of the control component 104.

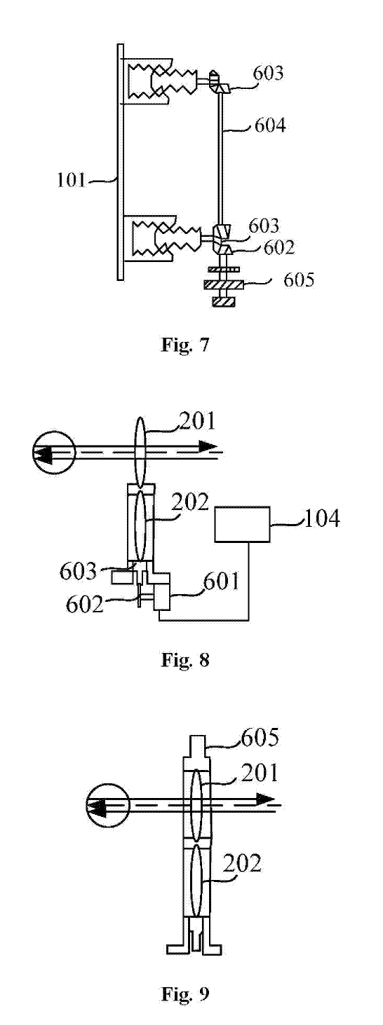

At a second condition, when the execution component 106 drives the display screen 101 to move according to manual control of the user, as shown in FIG. 7, the driving mechanism of the execution component 106 is the knob 605, and the user adjusts the knob 605 to adjust the transmission mechanism to drive the display screen 101 to move.

When the focusing component 102 includes more than two lenses with different focal lengths, adjustment of the focal length of the focusing component 102 includes the following two conditions.

At a first condition, when the execution component 106 drives the lens 201 in the focusing component 102 to move according to control of the control component 104, as shown in FIG. 8, the driving mechanism is the motor 601, the transmission mechanism is a gear transmission, divided into the driving gear 602 and the driven gear 603. And the motor 601 drives the driving gear 602 to drive the driven gear 603 according to the control of the control component 104 to move a lens 202 with the corresponding focal length to the original lens 201,

At a second condition, when the execution component 106 replaces the lens 201 according to manual control of the user, as shown in FIG. 9, the driving mechanism of the execution component 106 is the knob 605, and the user adjusts the knob 605 to move the lens 202 with the corresponding focal length to the original lens 201

In an exemplary implementation mode disclosed in embodiment one of the present disclosure, the head-mounted display device 100 further includes a memory, and the memory is connected with the control component 104.

The memory is configured to store any one or combination of at least one parameter of the focusing component 102, the ametropia value, the target focal length and the target distance.

In an exemplary implementation mode, in the technical solution disclosed in embodiment one of the present disclosure, the optometric component 103 includes an infrared light emission device 401, an optical system and an image sensor 409. FIG. 10 shows specific structure of the optometric component in the head-mounted display device 100. For convenient description, elaborations will be made below in combination with a detailed embodiment. In this embodiment, the head-mounted display device includes the driving mechanism 406 and transmission mechanism 405 in the execution component 106. And the driving mechanism 406 is a motor, and the transmission mechanism 405 is a gear transmission. The optometric component 103 includes the infrared light emission device 401, the optical system consisting of a diaphragm 407, a light shaping lens 402, a spectroscope 403, a dichroic mirror 404 and a fundus imaging lens 408, and the image sensor 409.

The infrared light emission device 402 is configured to emit infrared light. And the infrared light sequentially passes through the diaphragm 407, the light shaping lens 402, the spectroscope 403, the dichroic mirror 404 and the focusing component 102 to form a light spot at fundus of the user. And the light spot is reflected by the fundus and then reflected by the focusing component 102, the dichroic mirror 404 and the spectroscope 403, and is finally imaged in the image sensor 409 through the fundus imaging lens 408.

The role of the diaphragm 407 is to shield light on a central axis, and influence of an image reflected by the cornea of the user on retinal imaging may be avoided. The diaphragm 407 may be implemented by a pore, a ring, a pore array and the like, and the diaphragm 407 may also be not required herein.

The control component 104 may determine an ametropia condition, including myopia, hyperemia and astigmatism, of the user according to a shape of the light spot.

The image sensor 409, after acquiring the light spot, converts an optical signal of the light spot into an electrical signal and then sends the electrical signal to the control component 104. The control component 104 analyzes the shape and definition of the light spot received by the image sensor 407 through the received electrical signal. When the ametropia condition of the eye of the user is determined, according to the shape of the light spot, as myopia or hyperopia, the control component 104 controls the fundus imaging lens 408 to move to and fro along the optical axis until determining that the light spot acquired by the image sensor 409 is clearest, and determines a distance between the fundus imaging lens 408 and the focusing component 102 along the optical axis according to a displacement of the fundus imaging lens 408 driven by the motor.

When the ametropia condition of the eye of the user is determined, according to the shape of the light spot, as astigmatism and the fundus imaging lens 408 is moved, a minimum value of a central light spot is determined at first to measure an average degree of the diopter. And then the fundus imaging lens 408 is moved forwards and backwards at a position corresponding to the minimum value of the central light spot to distinguish a direction in which a line is clearer during forward movement and backward movement. When two positions where the definition is high being mutually perpendicular or approximately perpendicular, a direction of an astigmatism axis is determined, and the two positions where the definition is highest are acquired.

A movement manner for the fundus imaging lens 408 may include automatic movement and manual movement, and another lens with a different focal length may also be adopted instead for the fundus imaging lens 408. The specific movement manner and lens replacement manner are similar to a movement manner and focusing manner for the focusing component 102 and will not be elaborated herein.

When the diopter of the eyeball of the user is tested, the focal length of the focusing component 102 is known, recorded as F₁′, a focal length of the fundus imaging lens 408 is F₂′, the distance between the focusing component 102 and the image sensor 409 along the optical axis is c, and the distance between the fundus imaging lens 408 and the focusing component 102 along the optical axis is recorded as d₁. Then, the ametropia value of the user may be determined by a formula (2), and the formula (2) is represented as follows:

D=100/F₁′−100*(F₂′−c+d₁)/(d₁²−c*d₁+c*F₂′) (2)

When the ametropia condition of the eyeball of the user is myopia or hyperopia, the ametropia value may directly be determined by the formula (2), When the ametropia condition of the eyeball of the user is astigmatism, two ametropia values D1 and D2 may be determined through the two positions where the definition is highest, and a difference between the two ametropia values is astigmatism power.

A charge coupled device sensor or a metal oxide, semiconductor sensor may be adopted as the image sensor 409. There are no specific limits made herein.

In the whole embodiment one, the control component 104 includes a single-chip microcomputer, a digital signal processor or a central processing element. There are no specific limits made herein.

### Embodiment Two

Embodiment two of the present disclosure discloses an adjustment parameter determining method for a head-mounted display device. The head-mounted display device is the head-mounted display device 100 in any implementation mode disclosed in embodiment one. As shown in FIG. 5, a flow of the adjustment parameter determining method is as follows.

At Step 20, a focusing component 102 is made still relative to a display screen 101.

Before a diopter of an eyeball of a user is tested, the display screen 101 is positioned at a focal point of the focusing component 102 with a known focal length to make the focusing component 102 still relative to the display screen 101.

At Step 21, a diopter of an eyeball of a user is tested through an optometric component.

At Step 23, at least one adjustment parameter is determined through a control component 104 according to the diopter, and the at least one adjustment parameter includes at least one of a target focal length of the focusing component 102 and a target distance between the display screen 101 and the focusing component 102.

From the above analysis, it can be seen that, compared with a head-mounted display device in the related art, the head-mounted display device provided in the embodiments of the present disclosure has the advantages that the diopter of the user is acquired, and then at least one of the target focal length of the focusing component and the target distance between the display screen and the focusing component is determined according to the diopter, so that a basis is provided for adjusting at least one of the distance between the display screen and the focusing component and the focal length of the focusing component, and adjustment precision of the head-mounted display device is further improved.

A computer program product for the head-mounted display device and the adjustment parameter determining method for the head-mounted display device provided in the embodiments of the present disclosure includes a computer-readable storage medium storing at least one program code, and at least one instruction in the at least one program code may be configured to execute the method in the method embodiment. Specific implementation may refer to the method embodiment and will not be elaborated herein.

The head-mounted display device provided in the embodiments of the present disclosure may be specific hardware on equipment or software or firmware installed on the equipment. Implementation principles and technical effects of the devices provided in the embodiments of the present disclosure are the same as those of the method embodiments. For brief description, parts not mentioned in the device embodiments may refer to corresponding contents in the method embodiments. Those skilled in the art may clearly know that, for convenient and brief description, specific working processes of the system, devices and elements described above may refer to corresponding processes in the method embodiments and will not be elaborated herein.

In the embodiments provided in the present disclosure, it is to be understood that the disclosed device and method may be implemented in another manner. The device embodiment described above is schematic. For example, division of the elements is logic function division, and other division manners may be adopted during practical implementation. For another example, multiple elements or components may be combined or integrated into another system, or some characteristics may be neglected or not executed. In addition, coupling or direct coupling or communication connection between each displayed or discussed component may be indirect coupling or communication connection, implemented through some communication interfaces, of the device or the elements, and may be electrical and mechanical or adopt other forms.

The elements described as separate parts may or may not be physically separated, and parts displayed as elements may or may not be physical elements, and namely may be located in the same place or may also be distributed to multiple network elements. Part or all of the elements may be selected to achieve the purpose of the solutions of the embodiments according to a practical requirement.

In addition, each function element in the embodiments provided in the present disclosure may be integrated into a processing element, each element may also exist independently, and two or more than two elements may also be integrated into a element.

When being realized in form of software function element and sold or used as an independent product, the function may be stored in a computer-readable storage medium. Based on such an understanding, the technical solutions of the present disclosure substantially or parts making contributions to the related art or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the present disclosure. The storage medium includes: various media capable of storing program codes such as a U disk, a mobile hard disk, a Read-Only Memory (ROM), a Random Access Memory (RAM), magnetic disk or an optical disk.

It is to be noted that similar reference signs and letters represent similar terms in the, following drawings, so that a certain term, once being defined in a drawing, is not required to be further defined and explained in subsequent drawings. In addition, terms “first”, “second”, “third” and the like are adopted for differentiated description and should not be understood to indicate or imply relative importance.

It is finally to be noted that the above embodiments are specific implementation modes of the present disclosure adopted to not limit but describe the technical solutions of the present disclosure and not intended to limit the scope of protection of the present disclosure. Although the present disclosure is described with reference to the embodiments in detail, those of ordinary skill in the art should know that those skilled in the art may still make modifications or apparent variations to the technical solutions recorded in the embodiments or make equivalent replacements to part of technical characteristics therein within the technical scope disclosed in the present disclosure, and these modifications, variations or replacements do not make the essence of the corresponding technical solutions depart from the spirit and scope of the technical solutions of the embodiments of the present disclosure and shall also fall within the scope of protection of the present disclosure. Therefore, the scope of protection of the present disclosure should be subject to the scope of protection of the claims.

### INDUSTRIAL APPLICABILITY

As described above, the head-mounted display device and adjustment parameter determining method for the head-mounted display device provided in at least some embodiments of the present disclosure have the following beneficial effects: the diopter of the user is acquired, and then at least one of the target focal length of the focusing component and the target distance between the display screen and the focusing component is determined according to the diopter, so that a basis is provided for adjusting at least one of the distance between the display screen and the focusing component and the focal length of the focusing component, and adjustment precision of the head-mounted display device is further improved.

What is claimed is:

1. A head-mounted display device, comprising a display screen and the head-mounted display device further comprising a focusing component, an optometric component and a control component, wherein the focusing component is arranged in front of the display screen, and the control component is electrically connected with the optometric component;
the focusing component is configured to focus incident light during emergence;
the optometric component is configured to test a diopter of an eyeball of a user; and
the control component is configured to determine at least one of a target focal length of the focusing component and a target distance between the display screen and the focusing component according to the diopter.

2. The head-mounted display device as claimed in claim 1, wherein the diopter comprises an ametropia value or an ametropia degree.

3. The head-mounted display device as claimed in claim 1, wherein the head-mounted display device further comprises a prompting component, wherein the prompting component is connected with the control component; and
the prompting component is configured to prompt the user according to at least one of the target focal length and the target distance.

4. The head-mounted display device as claimed in claim 1, wherein the head-mounted display device further comprises an execution component wherein the execution component is respectively connected with, the control component, the display screen and the focusing component;
the focusing component comprises a plurality of lenses corresponding to different diopters;
the control component is further configured to control the execution component to drive at least one of the display screen and the focusing component to move according to the target distance, or, is further configured to control the execution component to replace the lens according to the target focusing length; and
the execution component is configured to drive at least one of the display screen and the focusing component to move according to control of the control component or manual control of a user, or, replace the lens according to control of the control component or manual control of a user.

5. The head-mounted display device as claimed in claim 4, wherein the execution component comprises a driving mechanism and a transmission mechanism, the driving mechanism is respectively connected with the control component and the transmission mechanism, and the transmission mechanism is respectively connected with the display screen and the focusing component;
the driving mechanism is configured to drive the transmission mechanism to move according to control of the control component or manual control of the user; and
the transmission mechanism is configured to drive at least one of the display screen and the focusing component to move according to driving of the driving mechanism or manual control of the user, or, replace the lens according to driving of the driving, mechanism or manual control of the user.

6. The head-mounted display device as claimed in claim 5, wherein the driving mechanism comprises a stepper motor or a servo motor.

7. The head-mounted display device as claimed in claim 5, wherein the transmission mechanism comprises a lead screw transmission mechanism, a rack transmission mechanism or a gear transmission mechanism.

8. The head-mounted display device as claimed in claim 1, wherein
the focusing component comprises a liquid crystal lens; and
the control component is further configured to control zooming of the liquid crystal lens of the focusing component according to the target focal length.

9. The head-mounted display device according to claim 3, wherein the prompting component comprises at least one of a voice component and a display component.

10. An adjustment parameter determining method for a head-mounted display device, the head-mounted display device being the head-mounted display device as claimed in claim 1 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length of the focusing component and a target distance between the display screen and the focusing component.

11. The head-mounted display device as claimed in claim 2, wherein the head-mounted display device further comprises a prompting component wherein the prompting component is connected with the control component; and
the prompting component is configured to prompt the user according to at least one of the target focal length and the target distance.

12. The head-mounted display device as claimed in claim 2, wherein the head-mounted display device further comprises an execution component, wherein the execution component is respectively connected with the central component, the display screen and the focusing component;
the focusing component comprises a plurality of lenses corresponding to different diopters;
the control component is further configured to control the execution component to drive at least one of the display screen and the focusing component to move according to the target distance, or, is further configured to control the execution component to replace the lens according to the target focusing length; and
the execution component is configured to drive at least one of the display screen and the focusing component to move according to control of the control component or manual control of a user, or, replace the lens according to control of the control component or manual control of a user.

13. The head-mounted display device as claimed in claim 2, wherein
the focusing component comprises a liquid crystal lens; and
the control component is further configured to control zooming of the liquid crystal lens of the focusing component according to the target focal length.

14. An adjustment parameter determining method for a head-mounted display device, the head-mounted display device being the head-mounted display device as claimed in claim 2 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length of the focusing component and a target distance between the display screen and the focusing component.

15. An adjustment parameter determining method for a head-mounted display device, the head-mounted display device being the head-mounted display device as claimed in claim 3 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length of the focusing component and a target distance between the display screen and the focusing component.

16. An adjustment parameter determining method for a head-mounted display device, the head-mounted display device being the head-mounted display device as claimed in claim 4 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length of the focusing component and a target distance between the display screen and the focusing component.

17. An adjustment parameter determining method for a head-mounted display device, the head-mounted display device being the head-mounted display device as claimed in claim 5 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length of the focusing component and a target distance between the display screen and the focusing component.

18. An adjustment parameter determining method for a head-mounted display device, the head-mounted display device being the head-mounted display device as claimed in claim 6 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length of the focusing component and a target distance between the display screen and the focusing component.

19. An adjustment parameter determining method for a head-mounted display device, the head-mounted display device being the head-mounted display device as claimed in claim 7 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length of the focusing component and a target distance between the display screen and the focusing component.

20. An adjustment parameter determining method for a head-mounted display device, the head-mounted display device being the head-mounted display device as claimed in claim 8 and the method comprising:
making a focusing component still relative to a display screen;
testing, through an optometric component, a diopter of an eyeball of a user; and
determining, through a control component, at least one adjustment parameter according to the diopter, the at least one adjustment parameter comprising at least one of a target focal length or the focusing component and a target distance between the display screen and the focusing component.
